(19) United States
(12) Patent Application Publication
(10) Pub. No.: US 2013/0346135 A1
(43) Pub. Date: Dec. 26, 2013

(54) Method And System For Servicing A Drop Safe

(71) Applicants: Jason B. Siemens, Beeton (CA); Guennadi Pribotchenkov, Toronto (CA)

(72) Inventors: Jason B. Siemens, Beeton (CA); Guennadi Pribotchenkov, Toronto (CA)

(21) Appl. No.: 13/531,029

(22) Filed: Jun. 22, 2012

(51) Int. Cl. G06Q 10/10

(52) U.S. Cl. 705/7.21

(57) ABSTRACT

A method of servicing a drop safe. Actual timing and amounts of deposits made to the drop safe are tracked over a predetermined number of historical days. Based on the tracked deposits, the timing and amounts of deposits to the drop safe are predicted for a predetermined number of future days. An optimal day for a carrier to pickup currency held in the drop safe is estimated from the predetermined number of future days. The optimal pickup day is based on: a) the predicted deposits spanning at least some of the predetermined number of future days; b) a currency holding capacity of said drop safe; c) a currency holding cost; d) a currency-in-transit cost; and e) a drop safe service cost. A pickup is arranged with the carrier on at least the one optimal pickup day. A system, and a computer readable medium carrying computer readable instructions for carrying out the method are also disclosed.

### FIELD OF THE INVENTION

The present invention relates to the field of drop safes. More particularly, the present invention relates to servicing of a drop safe.

### BACKGROUND OF THE INVENTION

Business establishments such as convenience stores, and restaurants, for example, typically handle large amounts of currency, particularly in the form of paper money, on a daily basis. To reduce the risk of the currency being stolen by robbers, these establishments tend to maintain only a minimal amount of currency in a cash register, and periodically transfer accumulated currency to an on-site safe or drop safe. A drop safe is preferred because it permits cashiers to deposit currency into the drop safe without giving the cashiers access to the contents of the drop safe. The drop safe is typically fitted with a slot into which the currency is either directly deposited, or the currency is first placed into an envelope before it is placed into the slot. In either case the currency is deposited into the drop safe without having to open the drop safe. Transferring the accumulated currency to the drop safe several times in a day reduces the amount of currency present at a cash register, thereby reducing the potential exposure of the currency to loss due to robbery.

Typically, the business establishment will have an agreement with a carrier, whether directly, or indirectly through a bank, to service the drop safe. Often times, the bank will have an agreement in place with a carrier to pickup the currency held in the drop safe and transport it to the bank for verification. Under such an agreement the bank will may provide daily provisional credit on the currency in the drop safe from when it is deposited into the drop safe through to when it is picked up, transported to the bank, and verified. If the business establishment has an agreement in place directly with the carrier, the carrier may make arrangements through a bank to provide the daily provisional credit from when it is deposited into the drop safe through to when it is picked up, transported to the bank, and verified. Daily provisional credit is a benefit to the business establishment because it means that the currency amounts deposited into the drop safe are credited to the business establishment's bank account on a daily basis, as opposed to more infrequent schedules based on when the pickup is actually made, which can be weekly, monthly, etc. However, this benefit comes at a cost. There is a cost to the bank for providing the daily provisional credit, or to the carrier for arranging to provide the daily provisional credit, on the currency while it is sitting in the drop safe, while it is in transit from the drop safe to the bank, while it is being verified by the bank, and through to when it is deposited to the business establishment's bank account. Occasionally there are also costs associated with security risks from holding a certain amount of currency in the drop safe. While there are costs associated with servicing the drop safe, there are also costs associated with not servicing the drop safe often enough and allowing the drop safe to reach its capacity before having it emptied by the carrier.

Examples of some prior art devices for holding and/or managing currency are disclosed in the U.S. Pat. Nos. 6,213,341; 7,219,083; and 7,813,972, as well as U.S. Pat. App. Nos.: 2004/0158539 and 2010/0082355.

U.S. Pat. No. 6,213,341 to Keith discloses a change dispensing apparatus having multiple columns for storing and vending tubes containing change in coin or in currency. At col. 19, lines 16 to 47 Keith provides that knowing dates and times for change delivery by an armoured car messenger service, the supervisor can manually request deliveries of change for the next scheduled delivery to that store. As an alternative to manual ordering based on the supervisor's personal estimate of change needs for the day of delivery and the following days until the next scheduled delivery, the change safe can predict the change needs based on historical change usage by day for the particular safe. Based on the average change requirements for each denomination, the known date for the next scheduled delivery of change, and the days between that delivery and the next subsequent scheduled delivery, the microprocessor sums the average usages on those days, for each denomination, and prepares a report of the predicted requirements for the next change delivery. The supervisor may then order the amount of change predicted by the change safe, or may vary that order based on other factors such as anticipated abnormal change requirements for a major holiday occurring between the next two scheduled deliveries of change. However, Keith does not disclose scheduling when to send the armoured messenger service, instead Keith relies on the existing schedule to calculate the amount of change required for the next regularly scheduled delivery. Thus, Keith appears to be concerned with forecasting currency demand, which is not useful for servicing a drop safe which relates only to currency accumulation. Keith also does not appear to be concerned with predicting an excess of currency in the change safe and scheduling the armoured messenger service to empty the change safe based on the prediction. Nor does Keith discuss the costs associated with the servicing of the change dispensing apparatus.

U.S. Pat. App. Pub. No. 2010/0082355 in the name of Folk discloses a cash handling device that is configured to determine shortages or overages of currency based on a maximum level, a minimum level and a target level. A target level defines a preferred level of currency to have in a currency handling device for a specified period. A maximum level refers to a level of funds where funds are likely to exceed the needs of the entity or a capacity of the physical storage component. In some instances, the maximum level may be defined based on a risk of theft (i.e., the greater the amount of funds in the machine, the greater risk of theft). A minimum level generally refers to a level of funds where funds are likely to run out over the specified period of time. The maximum and minimum levels, in one or more arrangements, may be defined based on the target level. Furthermore, the target level may be defined based on predictions of cash usage needs. The predictions may be formed based on historical usage, known events, user input and the like. Thus Folk appears to contemplate the currency handling device automatically generating a transport request to remove currency down to a predetermined target level based solely on predictions of cash usage needs. However, forecasting currency demand is not useful for servicing a drop safe which relies entirely on currency supply. Folk is also not concerned with the costs associated with the servicing of the cash handling device.

U.S. Pat. No. 7,813,972 to Ramos discloses a currency management system which creates a currency demand forecast for one or more nodes (i.e. traditional free-standing bank branch offices, or any other entities in a financial system that handles currency, such as kiosks or automated teller machines), using historical currency intake and output data for the nodes. The currency demand forecast is used to create a plan for transporting currency to one or more nodes. Ramos notes that it is important that a financial institution have adequate cash inventory on hand to meet any likely demand. According to an aspect of the system, there are a plurality of network nodes each of which distribute and receive currency and have a current currency balance. A demand planning module is programmed and configured to create a currency demand forecast for one or more nodes using historical currency intake and output data for the nodes. A transportation planning module is programmed and configured to create a transportation plan for supplies of currency and collections of currency for one or more nodes using the currency demand forecast and taking into account the currency handling costs. Currency handling costs are transportation costs, storage costs and robbery costs. According to Ramos, transportation costs can include personnel, vehicle costs, maintenance, and insurance. Storage costs involve the cost of storing currency in centralized vaults, and thus include lease, utility, personnel, maintenance, insurance, and other such costs. The robbery cost may be computed as the product of a robbery and a daily robbery probability. However, Ramos is concerned with the demand side of the currency handling systems, the focus being on ensuring that a financial institution has adequate cash inventory on hand to meet any likely demand. As mentioned above, forecasting currency demand is not useful for servicing a drop safe which relates only to currency accumulation. Furthermore, while Ramos appears to factor into the transportation plan costs associated with transportation, storage, and risk of robbery, there is room for improvement to select a pickup day which will reduce operating costs further.

### SUMMARY OF THE INVENTION

What is desired is an improved method and system for servicing a drop safe which overcomes at least some of the problems associated with the prior art. Preferably, the improved method and system will reduce costs of operating the drop safe by permitting a user to estimate the optimal day on which to have a carrier pickup the currency in the drop safe. The optimal pickup day is estimated from the timing and amounts of actual deposits made to the drop safe over a predetermined number of historical days. The optimal day is a pickup day in a predetermined number of future days when servicing the drop safe will result in lower overall costs for the period as compared to overall costs if the pickup was made the previous pickup day or if the pickup was deferred to the next pickup day. Accordingly, the focus of the present invention is on predicting a pickup day which balances costs of holding the currency in the drop safe against costs of having a carrier pick up the currency, as opposed to simply predicting when the drop safe will reach a currency holding capacity or a currency amount.

The optimal day is preferably selected by balancing various factors including, for example, predicted deposits spanning at least some predetermined number of future days, a currency holding capacity of the drop safe, a currency holding cost (i.e. a cost of providing daily credit on the currency held in the drop safe), a currency-in-transit cost (i.e. a cost of providing daily credit on the currency from the optimal day until a later day when the currency is verified), a drop safe service cost (i.e. a cost charged by the carrier for servicing the drop safe on the optimal day, which can be for example a fixed scheduled carrier pickup cost; or a variable scheduled carrier pickup cost), local holidays, local events, seasons, permitted carrier service days, required carrier service days, a maximum desired amount of currency held in said drop safe, a time of day when the carrier is expected to service the drop safe, carrier pickup schedules, required carrier lead times, and provisional credit rates.

Therefore, accordance with one aspect of the present invention there is disclosed a method of servicing a drop safe configured for holding currency, said method comprising the steps of:
tracking actual timing and amounts of deposits made to said drop safe over a predetermined number of historical days;
predicting future timing and amounts of deposits to said drop safe over a predetermined number of future days, said predicted deposits being based on said tracked deposits;
estimating which of said predetermined number of future days is optimal for a carrier to pickup said currency held in said drop safe, said optimal pickup day being based on:
   a) said predicted deposits spanning at least some of said predetermined number of future days;
   b) a currency holding capacity of said drop safe;
   c) a currency holding cost;
   d) a currency-in-transit cost; and
   e) a drop safe service cost; and
requesting said carrier to pickup said currency held in said drop safe on said optimal pickup day.

In accordance with another aspect of the present invention there is disclosed a computer readable medium carrying computer readable instructions for carrying out the above method.

In accordance with yet another aspect of the present invention there is disclosed a system for servicing a drop safe configured for holding currency, the system comprising:
a data connection to said drop safe;
a processor operably connected to said data connection, said processor being configured to:
   track via said data connection actual timing and amounts of deposits made to said drop safe over a predetermined number of historical days;
   predict future timing and amounts of deposits to said drop safe over a predetermined number of future days, said predicted deposits being based on said tracked deposits;
   estimate which of said predetermined number of future days is optimal for a carrier to pickup said currency held in said drop safe, said optimal pickup day being based on:
      a) said predicted deposits spanning at least some of said predetermined number of future days;
      b) a currency holding capacity of said drop safe;
      c) a currency holding cost;
      d) a currency-in-transit cost; and
      e) a drop safe service cost; and
an output device for displaying said optimal pickup day.

### BRIEF DESCRIPTION OF THE DRAWINGS

Reference will now be made to the preferred embodiments of the present invention with reference, by way of example only, to the following drawings in which:

FIG. 1 is a diagram of a system for servicing a drop safe according to an embodiment of the present invention;

FIG. 2 is a chart representing a historical usage dataset;

FIG. 3 is a chart representing a future usage dataset;

FIGS. 4 to 13 are charts showing cumulative provisional credit cost and pickup costs resulting from a carrier pickup on each one of the ten days in the future usage dataset;

FIG. 14 is a picture of a window on a computer display for allowing a user to input various parameters into a system according to an embodiment of the present invention;

FIG. 15 is a flow diagram showing how an optimal pickup day is estimated according to an embodiment of the present invention; and

FIG. 16 is a picture of a window on a computer display which includes a future usage dataset in the top half thereof, and a historical usage dataset in the bottom half thereof.

### DETAILED DESCRIPTION OF THE PREFERRED EMBODIMENTS

The present invention is described in more detail with reference to exemplary embodiments thereof as shown in the appended drawing. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

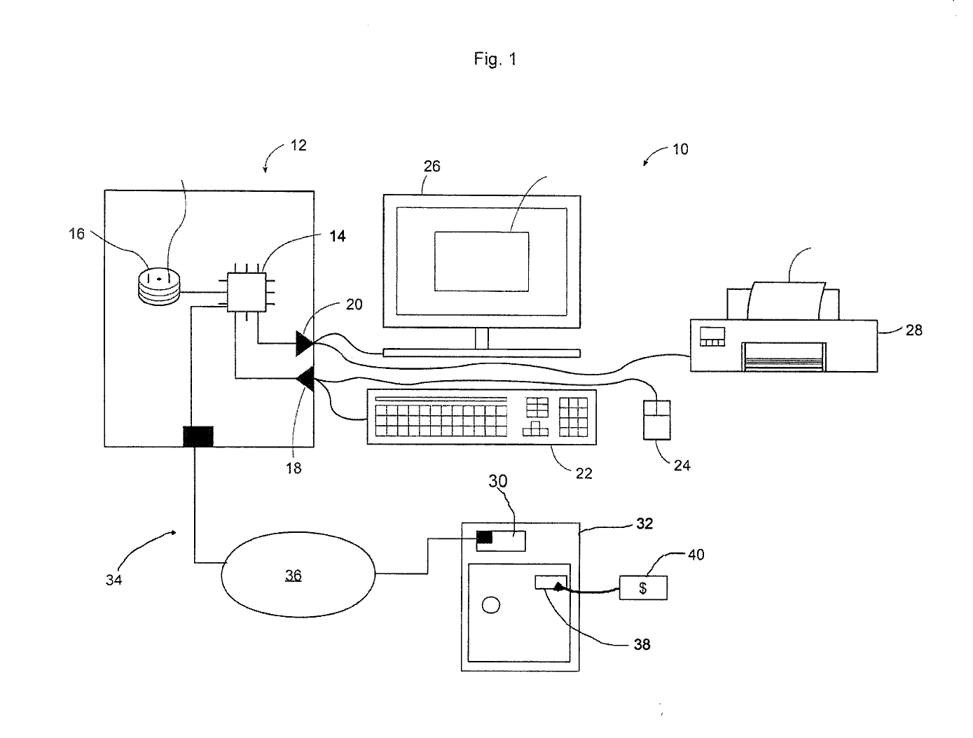

A system for servicing a drop safe according to an embodiment of the present invention is shown generally with reference numeral 10 in FIG. 1. The system 10 comprises a computer 12 housing, among other things typically found in a computer, a processor 14 associated with a storing means 16. The processor 14 is connected to an input port 18 and an output port 20. One or more input means such as for example a keyboard 22, a mouse 24, a keypad, a wireless transmitter, a computer readable medium, and/or a sound recognition device, may be connected to the processor 14 via the input port 16. One or more output means such as for example a display 26, a printer 28, a projector, a wireless transmitter, a computer readable medium, and/or a sound emitting device may be connected to the processor 14 via the output port 20.

The processor 14 is connected to a network module 30 housed in a drop safe 32, via a data connection 34. As will be appreciated, the data connection 34 may include one or more networks and/or web servers 36. The preferred drop safe 32 is of the type having a vault enclosing an interior chamber which is selectively accessible via a vault door. Housed in the interior chamber is a computing means, at least one currency acceptor and the network module. A slot is positioned on the door in alignment with the mouth of the currency acceptor 38 when the door is in the closed position allowing a user to insert currency directly into the currency acceptor 38 through the slot when the door is in the closed position and locked. The preferred currency 40 includes notes, such as for example paper currency. However, currency 40 in the form of coins as well as other forms is also contemplated by the present invention. The drop safe 32 may include other features and functions, and it may be associated with other devices. All such drop safes are contemplated by the present invention. While the preferred form of drop safe includes a microprocessor, the present invention can also be used with a “dumb” drop safe provided that enough data can be obtained to provide the needed historical usage data as described in more detail below.

The processor 14 is configured to track the actual timing and amount of each deposit made to the drop safe 32, via the data connection 34, over a predetermined number of historical days. Preferably the predetermined number of historical days is user selectable. The processor 14 is also configured to track the timing and amount of each pickup of currency from the drop safe 32. Based on the actual timing and amounts of the deposits and pickups, the processor 14 preferably generates a historical usage dataset including the following values:
i) actual total end-of-day amounts spanning the predetermined number of historical days; and
ii) actual total end-of-day counts spanning the predetermined number of historical days.

More preferably, the historical usage dataset also includes the following additional values for enhanced features:
i) actual daily deposit amounts spanning the predetermined number of historical days;
ii) actual daily deposit counts spanning the predetermined number of historical days.
iii) actual daily pickup amounts spanning the predetermined number of historical days; and
iv) actual daily pickup counts spanning the predetermined number of historical days.

For the purposes of this description, the term “amount” generally refers to the monetary value of the bills, notes, and/or coins, etc., deposited in, held in, or picked up from, the drop safe. The term “count”, on the other hand, generally refers to the number of each individual item of currency (i.e. each individual bills, note, and/or coin, etc.) deposited in, held in, or picked up from, the drop safe.

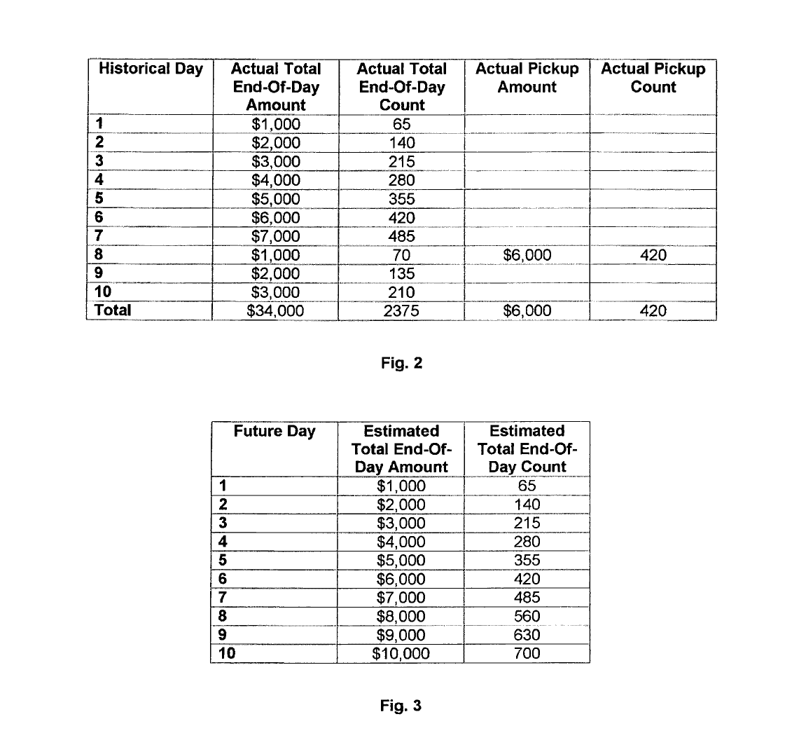

With reference to FIG. 2, there is shown a sample historical usage dataset spanning only ten historical days.

While good results have been obtained by tracking the actual daily deposits and pickups for at least 60 days, the predetermined number of historical days that are tracked by the processor 14 can be more or less than 60.

Based on the historical usage dataset the processor 14 predicts future timing and amounts of deposits to the drop safe 32 over a predetermined number of future days. Preferably, the processor 14 uses the historical usage dataset to generate a future usage dataset which includes estimated total end-of-day amounts, and estimated total end-of-day counts for each future day spanning the predetermined number of future days.

The future usage dataset preferably contains at least as many future days as a lead time required by a carrier. The carrier lead time is the minimum number of days in advance that a pickup request must be provided to the carrier to ensure a pickup on the day requested. However, good results have been obtained with the future usage dataset containing thirty future days.

In light of the present disclosure, a person skilled in the art will appreciate numerous ways by which to estimate the total end-of-day amounts and total end-of-day counts for inclusion in the future usage dataset. By way of example only, one way of generating the future usage dataset is to create models based on the historical usage dataset, as follows.

A historical usage dataset covering a period of at least three-hundred-sixty preceding historical days is generated using the tracked deposits and pickups. The historical usage dataset includes for each historical day at least values representing an actual amount of currency held in the drop safe 32 at the end of the day, and an actual count of currency held in the drop safe 32 at the end of the day. The amount of currency held in the drop safe refers to the monetary value of all of the bills, notes, and/or coins, etc., held in the drop safe. Similarly, the count of currency held in the drop safe refers to the total number of each individual item of currency, such as for example each individual bill, note, and/or coin, etc., held in the drop safe.

Next a future usage dataset covering a period of thirty future days is generated based on the historical usage dataset. FIG. 3 shows a sample future usage dataset spanning only ten historical days. The future usage dataset includes for each future day values representing an estimated amount of currency held in the drop safe 32 at the end of the day (i.e. estimated total end-of-day amount), and an estimated count of currency held in the drop safe 32 at the end of the day (i.e. estimated total end-of-day count). The estimated amount of currency held in the drop safe refers to the estimated monetary value of all of the bills, notes, and/or coins, etc., held in the drop safe. Similarly, the estimated count of currency held in the drop safe refers to the estimated total number of each individual item of currency, such as for example each individual bill, note, and/or coin, etc., held in the drop safe.

The estimated total end-of-day amounts for the thirty future days are obtained with a model created using the historical usage dataset. For example, five models are created by regressing the actual end-of-day amount for each historical day of the historical usage dataset spanning 60, 120, 180, 270, and 360 historical days upon day of week, day of month, and month of year categories using an algorithm implementing Levenberg-Marquard linear regression (obtained from an open source Java® library available online from Apache Commons™ at http://commons.apache.org/math/). Each of the five models is then compared to the historical usage dataset by comparing the root squared mean error. The model with the lowest root square mean error is selected and used to generate the thirty estimated total end-of-day amounts for the future dataset.

While the estimated total end-of-day counts can be obtained in the same way as the estimated total end-of-day amounts, good results may be obtained by estimating the total end-of-day counts from the estimated total end-of-day amounts as follows.

Each of the estimated total end-of-day counts is calculated by multiplying each of the estimated total end-of-day amounts by a count factor. The preferred count factor is obtained by:
a) calculating a first sum of actual total end-of-day amounts spanning the predetermined number of historical days in the historical usage dataset;
b) calculating a second sum of actual total end-of-day counts spanning the predetermined number of historical days; and
c) dividing the first sum by the second sum.

By way of example, the sample historical usage dataset in FIG. 2 shows the first sum of actual total end-of-day amounts spanning the ten historical days to be $40,000 (i.e. $34,000+$6,000). The second sum of actual total end-of-day counts spanning the same ten historical days is 2795 (i.e. 2375+420=2795). Thus the note factor is 14.311 (i.e. $40,000+2795=14.311). Dividing each of the estimated total end-of-day amounts by the note factor and rounding up to the nearest whole number yields the estimated total end-of-day counts.

Once the future usage dataset is generated it can be displayed on the display 26, printed using the printer 28, and/or stored on the storing means 16. Preferably, the processor 14 is also configured to permit the user to modify the future usage dataset via the input means.

Next the processor 14 estimates which of the predetermined number of future days in the future usage dataset, in this example ten future days, is optimal for a carrier to pick up the currency held in the drop safe 32.

As will be discussed in more detail, the optimal pickup day is preferably estimated based on:
a) a currency holding capacity of the drop safe;
b) a currency holding cost;
c) a currency-in-transit cost; and
d) a drop safe service cost.

The currency holding capacity is the maximum number of currency (i.e. bills, notes, coins, etc.) that the drop safe 32 can physically accept. In view of the fact that reaching the currency holding capacity of the drop safe 32 before a scheduled pickup day is a major inconvenience to the business establishment, the processor 14 is preferably configured to ensure that the estimated optimal pickup day is before a future day when the estimated total end-of-day count is greater than the drop safe's currency holding capacity, or some threshold count value less than the drop safe's currency holding capacity (i.e. threshold count=80% of capacity). However, it may also be desirable to configure the processor 14 to ensure that the estimated optimal pickup day is before a future day when the estimated currency amount is greater than some predetermined value, which may be determined based on factors relating to for example a risk of robbery.

The currency holding cost includes a cost for a bank to provide provisional credit on the currency for each day it is held in the drop safe. For example, in a service arrangement between a business establishment and a bank, the bank may provide the daily provisional credit. In a service arrangement between a business establishment and a carrier, the carrier may arrange with a bank to provide the daily provisional credit.

The currency-in-transit-cost includes a cost for a bank to provide provisional credit on the currency for each day it is in transit, namely from the estimated optimal pickup day until a later day when the currency is verified and deposited into the business establishment's bank account.

The drop safe service cost includes a cost charged by the carrier for servicing the drop safe on the estimated optimal pickup day. For example, the drop safe service cost may be based on one or more of a fixed scheduled carrier pickup cost, a variable scheduled carrier pickup cost, a transport cost, a deposit verification cost, an insurance cost, etc.

With reference to FIG. 4, there is shown a forecasted usage dataset spanning ten future days, assuming a pick up of zero dollars is made at the start of business on future day one. The forecasted usage dataset in FIG. 4 also assumes a currency holding cost from a daily provisional credit based on an annual interest rate of 5%, no currency-in-transit cost, and a drop safe service cost of $10.

For example, the daily provisional credit cost for future days one to ten are calculated as follows:
Future Day 1: $1,000×(0.05/365)=$0.137;
Future Day 2: $1,000×(0.05/365)+2($1,000×(0.05/365)=$0.411;
Future Day 3: $1,000×(0.05/365)+2($1,000×(0.05/365)+3($1,000×(0.05/365)=$0.822;
Future Day 4: $1,000×(0.05/365)+2($1,000×(0.05/365)+3($1,000×(0.05/365)=$0.822+4($1,000×(0.05/365)=$1.37;
. . .
Future Day 10: $1,000×(0.05/365)+2($1,000×(0.05/365)+3($1,000×(0.05/365)=$0.822+4($1,000×(0.05/365) . . . +10(0.05/365)=$7.535.

As can be seen, under this scenario, if a pickup is made on the first future day the overall cost for the predetermined number of future days, which in this example is ten future days, is estimated to be $40.14.

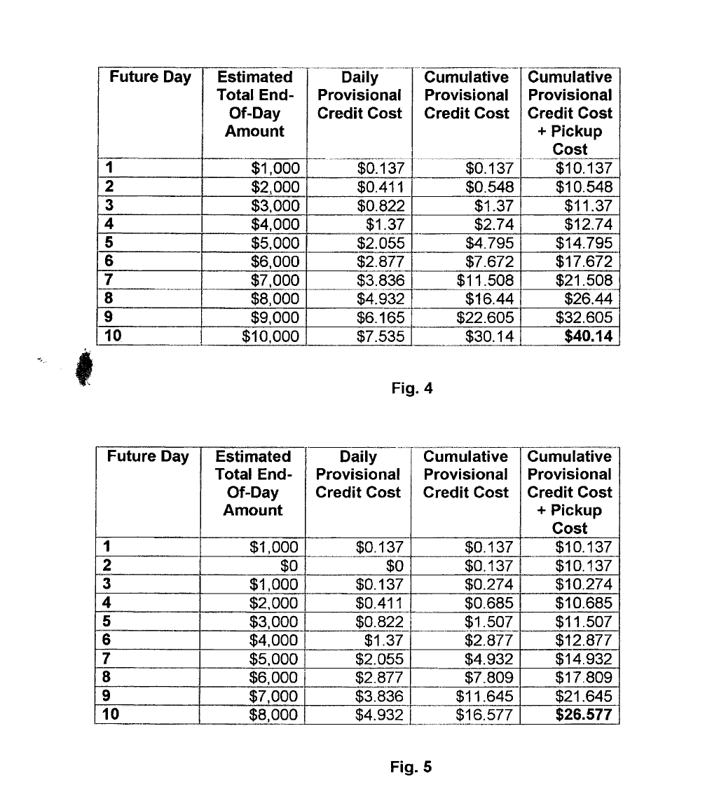

Continuing with FIG. 5, there is shown a forecasted usage dataset similar to the one in FIG. 4, but assuming a pickup of $1,000 is made at the start of business on future day two. As can be seen, in this example, if a pickup is made on the second future day the overall cost for the ten day period is estimated to be $26.58. It can also be seen that a pickup on future day two results in a lower overall cost for the ten day period, as compared to a pickup on future day one.

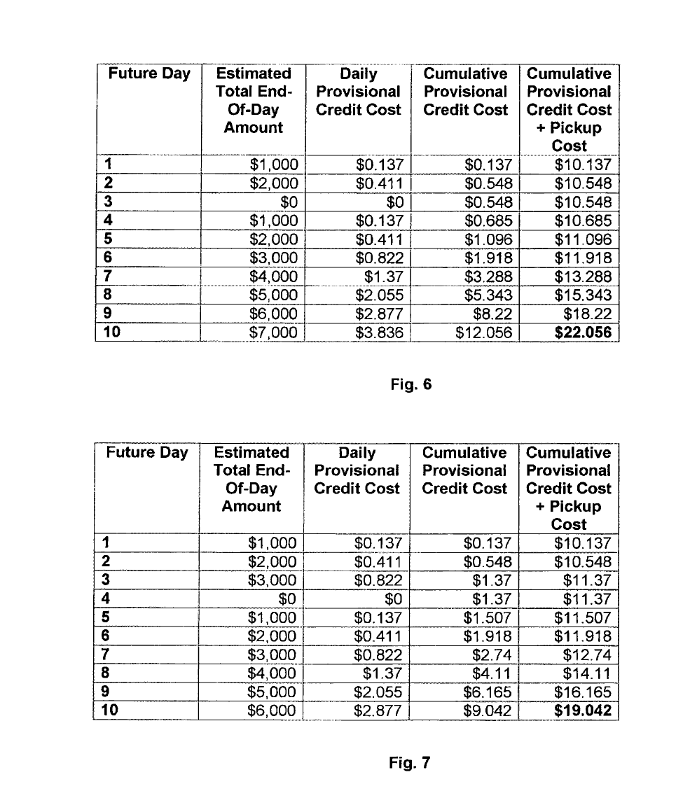

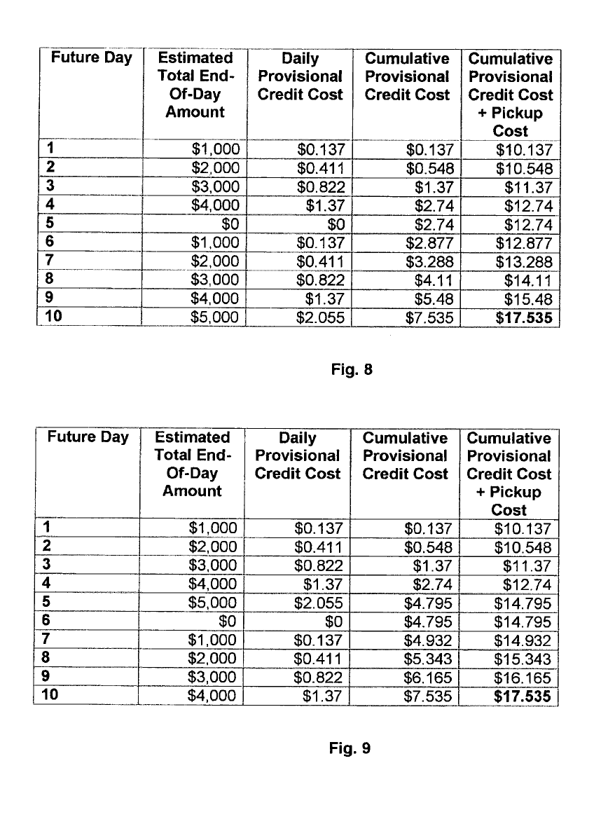

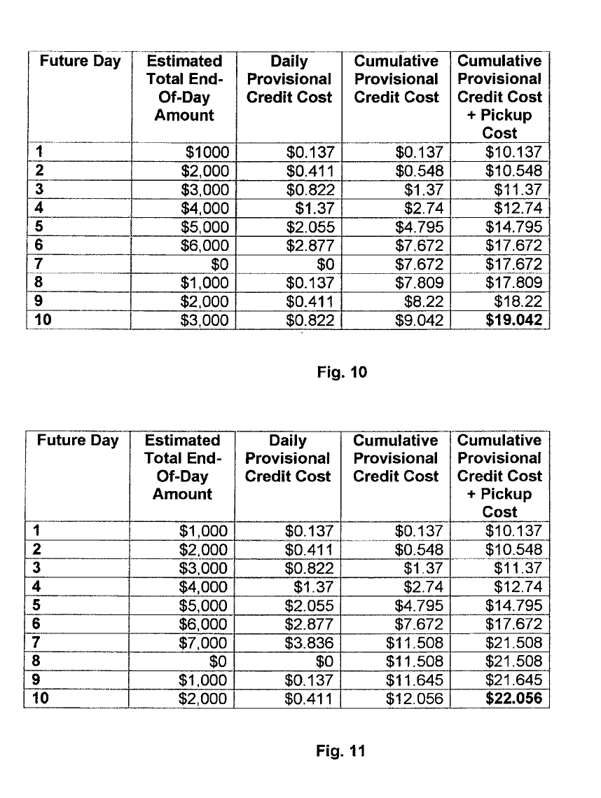

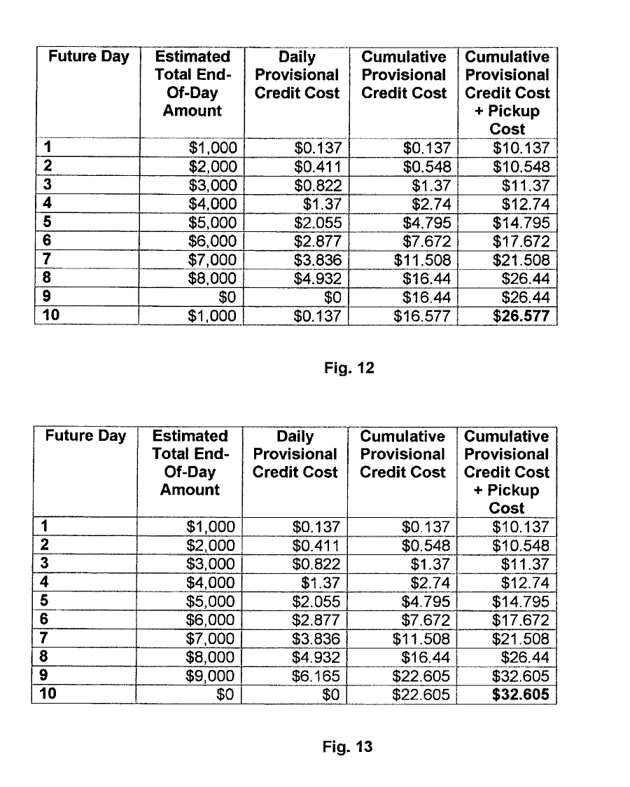

Continuing with FIGS. 6 to 13, there are shown forecasted usage datasets similar to the ones in FIGS. 4 and 5 assuming pickups being made at the start of business on future days three to ten, respectively.

Table 1 below shows for each of the ten future days, the estimated overall cost in the ten day period were a pickup is made on that day.

| | Estimated Overall |
|---|---|
| Future Day | Cost for Pickup |
| 1 | $40.14 |
| 2 | $26.58 |
| 3 | $22.06 |
| 4 | $19.04 |
| 5 | $17.54 |
| 6 | $17.54 |
| 7 | $19.04 |
| 8 | $22.06 |
| 9 | $26.58 |
| 10 | $32.61 |

As can be seen, the estimated overall cost decreases from future day one to future day five. The overall cost for future day six is the same as for future day five. The overall cost then increases from future day six to future day ten.

Thus according to this example, considering only the drop safe service cost, and costs based on provisional credit (i.e. the currency holding cost and the currency-in-transit cost), the estimated optimal pickup day would be a tie between future day five and future day six. There are various ways of dealing with ties, such as for example setting a rule that if a tie occurs the estimated optimal pickup day will be the latest of the future days associated with the lowest overall cost. According to such a rule, the above example would result in future day seven being the estimated optimal pickup day.

Preferably, however, the estimated optimal pickup day is further based on one or more of permitted carrier service days, required carrier service days, and a required carrier service lead time. Permitted carrier service days are weekdays when the carrier is able to fulfill a request to service the drop safe. Required carrier service days are weekdays when the carrier must service the drop safe. A required carrier lead time is the number of days in advance the service request must be provided to the carrier to ensure the carrier will service the drop safe. Typically the carrier service lead time is one day, meaning that in order to have the drop safe serviced on Wednesday, the request must be submitted the day before (i.e. on Tuesday).

Preferably, the estimated optimal pickup day is further based on a pre-service count. The pre-service count is a percentage of the daily end-of-day counts occurring before a scheduled pickup on a pickup day. For example, if it is known that a carrier is scheduled to make a pickup at 1 pm, and it is also known that prior to the scheduled fpm service, the drop safe receives 80% of the daily end-of-day counts, then it can be estimated that after the service by the carrier, the drop safe will have only 20% of the daily end-of-day counts. In other words, while it may be estimated that drop safe will reach or exceed its currency capacity by the end of the day, it may be within its currency capacity up to the time that it is serviced by the carrier. Furthermore, in view of the pickup of 80% of the daily counts for the day, the drop safe may also be within the currency capacity to the end of that day. Thus taking into account the pre-service count the estimated optimal pickup day may be deferred to another pickup day.

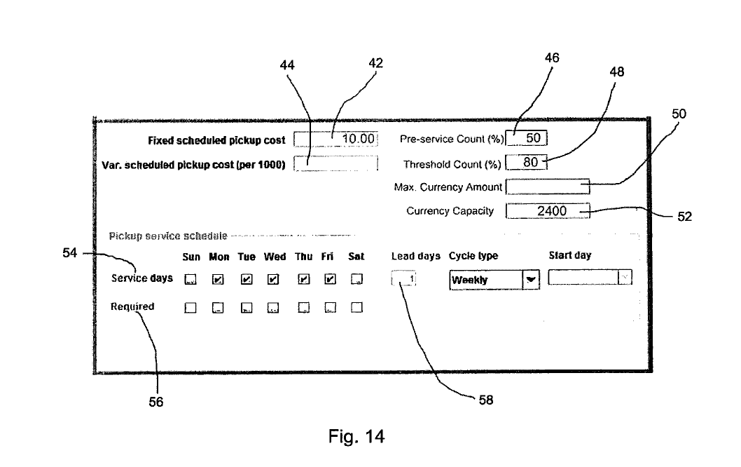

FIG. 14 shows a picture of a window presented for example on display 26, which a user can use to input into the processor 14 the following values via the keyboard 22 and mouse 24:
fixed scheduled pickup cost 42;
variable scheduled pickup cost 44;
pre-service count (%) 46;
threshold count (%) 48;
maximum currency amount 50;
currency holding capacity 52;
permitted carrier service days 54;
required carrier service days 56; and
required carrier lead time 58.

Preferably, the estimated optimal pickup day is further based on one or more of local holidays, local events, and business cycles. For example, local holidays and local events can indicate days that are not available for servicing the drop safe, or they may indicate days where the estimated currency amounts and counts are higher or lower than usual. With respect to taking into account business cycles based on seasons, it has been found that a minimum of thirteen months of historical usage data is required to generate the future usage data.

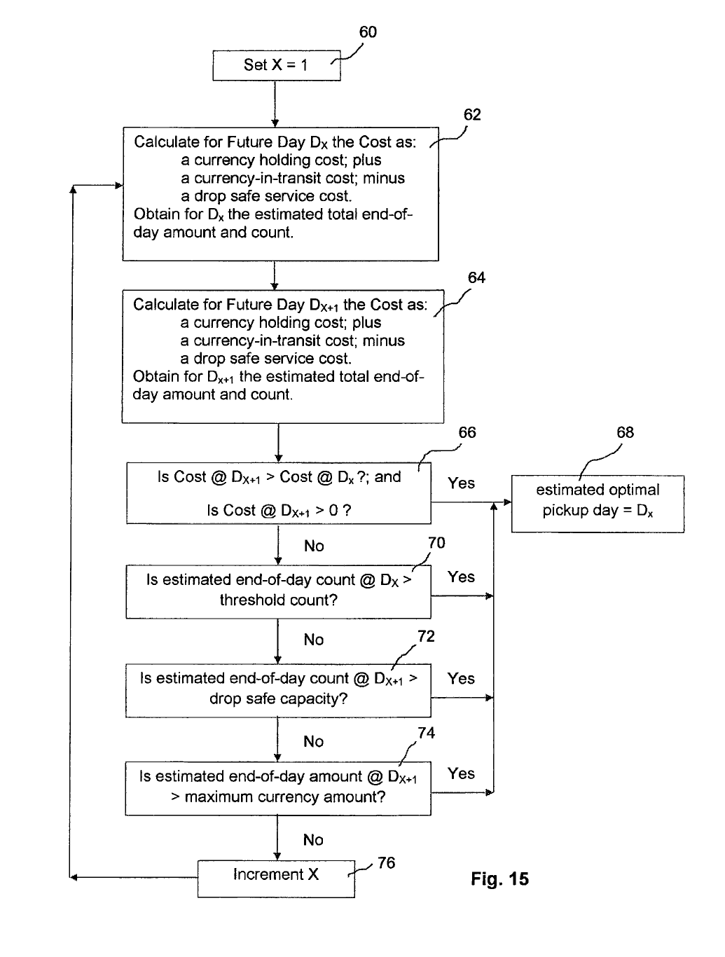

Referring to FIG. 15 there is shown a flow diagram with boxes 60 to 78 showing a preferred way by which the processor 14 estimates the optimal pickup day based on currency holding cost, currency-in-transit cost, drop safe service cost, drop safe capacity, drop safe threshold count (i.e. a threshold value less than the drop safe's currency holding capacity), and maximum desired amount of currency held in said drop safe (i.e. maximum currency amount).

At box 60 X is set to 1 for the purpose of conveying the iterative nature of the flow diagram.

Next at box 62 there is calculate in association with the future day Dₓ, for example the first future day D₁, the sum of the currency holding cost, the currency-in-transit-cost, and the drop safe service cost over the predetermined number of future days, assuming the drop safe 32 is serviced on D₁ (hereinafter “the Cost at D₁). Also the estimated total end-of-day amount and count are obtained for future day D₁.

Next at box 64 there is calculate in association with the next future day, for example future day D₂, the sum of the currency holding cost, the currency-in-transit-cost, and the drop safe service cost over the predetermined number of future days, assuming the drop safe 32 is serviced on D₂ (hereinafter “the Cost at D₂). Also the estimated total end-of-day amount and count are obtained for future day D₂.

At box 66 the Cost at D₁ is compared to the Cost at D₂. If the Cost at D₂ is greater than the Cost at D₁, and Cost at D₂ is a positive value, then proceeding to box 68 will show the estimated optimal pickup day is D₁. If the Cost at D₂ is not greater than the Cost at D₁, and/or the Cost at D₂ is negative, then proceeding to box 70 will require another comparison.

At box 70 the estimated end-of-day count at D₁ is compared to the threshold count. For example assuming that the drop safe currency holding capacity is 2,400, and the threshold count (%) 48 is set to 80%, then the threshold count will be 1920. If the estimated end-of-day count at D₁ is greater than the threshold count (for example 1920) then proceeding to box 68 will show the estimated optimal pickup day is D₁. If the estimated end-of-day count at D₁ is not greater than the threshold count then proceeding to box 72 will require another comparison.

At box 72 the estimated end-of-day count at D₂ is compared to the drop safe currency holding capacity 52 (for example 2400). If the estimated end-of-day count at D₂ is greater than the currency holding capacity 52 then proceeding to box 68 will show the estimated optimal pickup day is D₁. If the estimated end-of-day count at D₂ is not greater than the currency holding capacity 52 then proceeding to box 74 will require another comparison.

At box 74 the estimated end-of-day amount at D₂ is compared to the maximum currency amount 50. If the estimated end-of-day amount at D₂ is greater than the maximum currency amount 50 then proceeding to box 68 will show the estimated optimal pickup day is D₁.

If the estimated end-of-day amount at D₂ is not greater than the maximum currency amount 50 then proceeding to box 76 increment X before proceeding back to box 62. Accordingly, the process will repeat with future days D₂ and D₃, then future days D₃ and D₄, and so on until either an optimal pickup day is estimated or every one of the predetermined number future days in the predetermined number of future days has been considered.

Once the processor 14 estimates which of the predetermined number of future days is optimal for a carrier to pickup the currency 40 held in the drop safe 32, the estimated optimal pickup day may be displayed on an output device associated with the system 10. For example, the estimated optimal pickup day may be displayed on a display 26 or printed using printer 28. A user may then request the carrier to pickup the currency 40 held in the drop safe on the estimated optimal pickup day. As will be appreciated, the request may be in the form of a voice or data transmission. The data transmission may be sent manually at the direction of the user, or automatically without user involvement. The data transmission may wired or wireless and with or without intermediate networks or webservers.

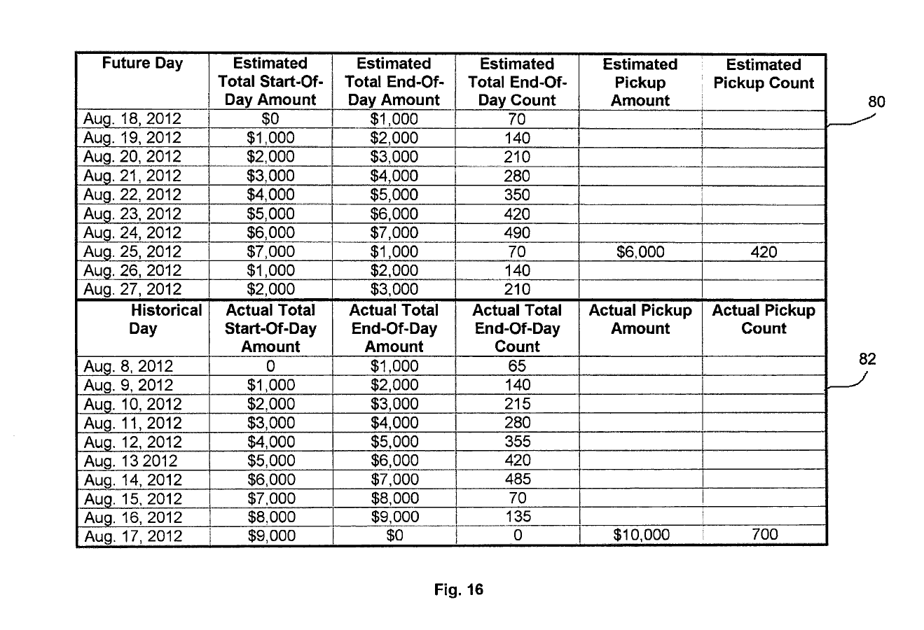

FIG. 16 shows picture of a window for example on display 26 which includes a future usage dataset in the top half thereof, and a historical usage dataset in the bottom half thereof. Preferably, the window is configured to permit a user to interact therewith via the keyboard 22 and mouse 24, to change values in the future usage dataset and the historical usage dataset, and see the results of those changed values in realtime. In this example the future days are mapped on to actual calender days.

It will be understood that once the processor 14 estimates which of the predetermined number of future days is optimal for the carrier to pickup the currency 40 held in the drop safe 32, it can estimate one or more subsequent optimal pickup days. For example, a subsequent optimal pickup day may be estimated by assuming a pickup is made by the carrier on the estimated optimal pickup day and proceeding through the predetermined number of future days in the same way as has been described for estimating the optimal pickup day.

Furthermore, having the benefit of the above description involving various steps for estimating the optimal pickup day, other mathematical alternatives for estimating the optimal pickup day will be appreciated by persons skilled in the art. All of which are comprehended by the present invention.

As will be appreciated by persons skilled in the art, in view of the above, the processor 14 of system 10 operates based on programming in the form of computer readable instructions for carrying out a method for servicing the drop safe described above. Accordingly, the instructions may be stored on or carried by a computer readable medium now available, or those yet to be developed, including without limitation a memory stick, a CD, a DVD, a hard drive (internal or external), or on a remote server accessible to the processor via wired or wireless internet or intranet. Furthermore, as will be appreciated, the computer readable instructions may be located on a computer readable medium which is operable upon an interactive website that is accessible by a user.

While reference has been made to various preferred embodiments of the invention other variations, implementations, modifications, alterations and embodiments are comprehended by the broad scope of the appended claims. Some of these have been discussed in detail in this specification and others will be apparent to those skilled in the art. Those of ordinary skill in the art having access to the teachings herein will recognize these additional variations, implementations, modifications, alterations and embodiments, all of which are within the scope of the present invention, which invention is limited only by the appended claims.

1. A method of servicing a drop safe configured for holding currency, said method comprising the steps of:
tracking actual timing and amounts of deposits made to said drop safe over a predetermined number of historical days;
predicting future timing and amounts of deposits to said drop safe over a predetermined number of future days, said predicted deposits being based on said tracked deposits;
estimating which of said predetermined number of future days is optimal for a carrier to pickup said currency held in said drop safe, said optimal pickup day being based on:
a) said predicted deposits spanning at least some of said predetermined number of future days;
b) a currency holding capacity of said drop safe;
c) a currency holding cost;
d) a currency-in-transit cost; and
e) a drop safe service cost; and
requesting said carrier to pickup said currency held in said drop safe on said estimated optimal pickup day.

2. The method according to claim 1, wherein said currency holding cost includes a cost of providing daily credit on said currency held in said drop safe.

3. The method according to claim 1, wherein said currency-in-transit cost includes a cost of providing daily credit on said currency from said optimal pickup day until a later day when said currency is verified.

4. The method according to claim 1, wherein said drop safe service cost includes a cost charged by said carrier for servicing said drop safe on said at least one optimal day.

5. The method according to claim 4, wherein said drop safe service cost is based on one or more of:
a fixed scheduled carrier pickup cost; and
a variable scheduled carrier pickup cost.

6. The method according to claim 5, wherein said drop safe service cost is further based on one or more of:
a transport cost;
a deposit verification cost; and
an insurance cost.

7. The method according to claim 1, wherein said optimal pickup day is further based on one or more of:
local holidays;
local events; and
business cycles.

8. The method according to claim 1, wherein said optimal pickup day is further based on one or more of:
permitted carrier service days;
required carrier service days; and
a required carrier service lead time.

9. The method according to claim 1, wherein said tracking step includes generating a historical usage dataset comprising the following values:
i) actual daily deposit amounts over said predetermined number of historical days; and
ii) actual daily deposit counts over said predetermined number of historical days.

10. The method according to claim 9, wherein said historical usage dataset further comprises the following additional values:
iii) actual daily pickup amounts spanning said predetermined number of historical days;
iv) actual daily pickup counts spanning said predetermined number of historical days;
v) actual total end-of-day amounts spanning said predetermined number of historical days; and
vi) actual total end-of-day counts spanning said predetermined number of historical days.

11. The method according to claim 10, wherein said additional values are derived from said values.

12. The method according to claim 9, wherein said predicted deposits are based on a linear regression of said actual daily deposit amounts spanning said predetermined number of historical days using an algorithm implementing Levenberg-Marquard linear regression.

13. The method according to claim 1, wherein said historical usage dataset spans at least 60 historical days.

14. The method according to claim 1, wherein said optimal pickup day is further based on a maximum desired amount of currency held in said drop safe.

15. The method according to claim 1, wherein said optimal pickup day is further based on a time of day when the carrier is expected to service the drop safe.

16. The method according to claim 1, wherein said predicting step includes generating a forecasted usage dataset comprising the following values:
i) estimated total end-of-day amounts spanning said predetermined number of future days; and
ii) estimated total end-of-day counts spanning said predetermined number of future days.

17. The method according to claim 16, wherein each of said estimated total end-of-day counts is calculated by multiplying each of said estimated total end-of-day amounts by a note factor, said note factor being obtained by:
a) calculating a first sum of actual daily deposit amounts and actual daily pickup amounts spanning said predetermined number of historical days;
b) calculating a second sum of actual daily deposit counts and actual daily pickup counts spanning said predetermined number of historical days; and
c) dividing said first sum by said second sum.

18. The method according to claim 16, wherein said forecasted usage dataset further comprises at least one estimated pickup amount associated with said estimated optimal pickup day.

19. The method according to claim 16, further comprising a step of enabling a user to modify said forecasted usage data after said forecasted usage data is generated.

20. The method according to claim 1, further comprising the steps of:
estimating which of said predetermined number of future days is a subsequent optimal day for a carrier to pickup said currency held in said drop safe, said subsequent optimal pickup day being based on:
a) said predicted deposits spanning at least some of said predetermined number of future days;
b) said currency holding capacity of said drop safe;
c) said currency holding cost;
d) said currency-in-transit cost;
e) said drop safe service cost; and
f) a pickup by said carrier of said currency in said drop safe on said estimated optimal pickup day.

21. (canceled)

22. A system for servicing a drop safe configured for holding currency, the system comprising:
a data connection to said drop safe;
a processor operably connected to said data connection, said processor being configured to:
track via said data connection actual timing and amounts of deposits made to said drop safe over a predetermined number of historical days;
predict future timing and amounts of deposits to said drop safe over a predetermined number of future days, said predicted deposits being based on said tracked deposits;
estimate which of said predetermined number of future days is optimal for a carrier to pickup said currency held in said drop safe, said optimal pickup day being based on:
a) said predicted deposits spanning at least some of said predetermined number of future days;
b) a currency holding capacity of said drop safe;
c) a currency holding cost;
d) a currency-in-transit cost; and
e) a drop safe service cost; and
an output device for displaying said estimated optimal pickup day.

23. The system according to claim 22, wherein said currency holding cost includes a cost of providing daily credit on said currency held in said drop safe.

24. The system according to claim 22, wherein said currency-in-transit cost includes a cost of providing daily credit on said currency from said optimal pickup day until a later day when said currency is verified.

25. The system according to claim 22, wherein said drop safe service cost includes a cost charged by said carrier for servicing said drop safe on said at least one optimal day.

26. The system according to claim 25, wherein said drop safe service cost is based on one or more of:
a fixed scheduled carrier pickup cost; and
a variable scheduled carrier pickup cost.

27. The system according to claim 26, wherein said drop safe service cost is further based on one or more of:
a transport cost;
a deposit verification cost; and
an insurance cost.

28. The system according to claim 22, wherein said optimal pickup day is further based on one or more of:
local holidays;
local events; and
business cycles.

29. The system according to claim 22, wherein said optimal pickup day is further based on one or more of:
permitted carrier service days;
required carrier service days; and
a required carrier service lead time.

30. The system according to claim 22, wherein said processor is further configured use said tracked timing and amounts of deposits to generate a historical usage dataset comprising the following values:
i) actual daily deposit amounts over said predetermined number of historical days; and
ii) actual daily deposit counts over said predetermined number of historical days.

31. The system according to claim 30, wherein said historical usage dataset further comprises the following additional values:
iii) actual daily pickup amounts spanning said predetermined number of historical days;
iv) actual daily pickup counts spanning said predetermined number of historical days;
v) actual total end-of-day amounts spanning said predetermined number of historical days; and
vi) actual total end-of-day counts spanning said predetermined number of historical days.

32. The system according to claim 31, wherein said additional values are derived from said values.

33. The system according to claim 30, wherein said predicted deposits are based on a linear regression of said actual daily deposit amounts spanning said predetermined number of historical days using an algorithm implementing Levenberg-Marquard linear regression.

34. The system according to claim 30, wherein said historical usage dataset spans at least 60 historical days.

35. The system according to claim 22, wherein said optimal pickup day is further based on a maximum desired amount of currency held in said drop safe.

36. The system according to claim 22, wherein said optimal pickup day is further based on a time of day when the carrier is expected to service the drop safe.

37. The system according to claim 22, wherein said processor is further configured to use said predicted deposits to generate a forecasted usage dataset comprising the following values:
i) estimated daily deposit amounts spanning said predetermined number of future days; and
ii) estimated daily deposit counts spanning said predetermined number of future days.

38. The system according to claim 37, wherein each of said estimated daily deposit counts is calculated by multiplying each of said estimated daily deposit amounts by a note factor, said note factor being obtained by:
a) calculating a first sum of actual daily deposit amounts and actual daily pickup amounts spanning said predetermined number of historical days;
b) calculating a second sum of actual daily deposit counts and actual daily pickup counts spanning said predetermined number of historical days; and
c) dividing said first sum by said second sum.

39. The system according to claim 37, wherein said forecasted usage dataset further comprises at least one estimated pickup amount associated with said optimal pickup day.

40. The system according to claim 37, further comprising an input means associated with said processor, wherein said processor is further configured to enable a user to modify said forecasted usage dataset via said input means after said forecasted usage dataset is generated.

41. The system according to claim 22, wherein said processor is further configured to estimate which of said predetermined number of future days is a subsequent optimal day for a carrier to pickup said currency held in said drop safe, said subsequent optimal pickup day being based on:
a) said predicted deposits spanning at least some of said predetermined number of future days;
b) said currency holding capacity of said drop safe;
c) said currency holding cost;
d) said currency-in-transit cost;
e) said drop safe service cost; and
f) a pickup by said carrier of said currency in said drop safe on said optimal pickup day.

42. The system according to claim 22, further comprising a data connection to said carrier for relaying said optimal pickup day.
